(19) United States
(12) Patent Application Publication
(10) Pub. No.: US 2024/0392140 A1
(43) Pub. Date: Nov. 28, 2024

(54) DUAL OVENABLE, REPULPABLE COATED PAPERBOARD FOR FOOD CONTAINERS AND METHOD FOR MANUFACTURING THEREOF

(71) Applicant: WestRock MWV, LLC, Atlanta, GA (US)

(72) Inventors: William STATELMAN, Richmond, VA (US); Tyler G. MILGRAM, Providence Forge, VA (US)

(21) Appl. No.: 18/654,920

(22) Filed: May 3, 2024

Related U.S. Application Data
(60) Provisional application No. 63/504,007, filed on May 24, 2023.

(51) Int. Cl. C09D 5/16; B65D 1/34; B65D 65/42; B65D 81/34; C09D 133/04; D21J 1/08

(52) U.S. Cl. CPC C09D 5/1662; B65D 1/34; B65D 65/42; B65D 81/343; C09D 133/04; D21J 1/08

(57) ABSTRACT

A method for manufacturing a dual ovenable, repulpable coated cellulosic board for forming food containers includes: coating an aqueous-based acrylic polymer blend barrier basecoat on a first major side of a cellulosic board substrate; and coating an aqueous-based acrylic polymer blend barrier topcoat on the aqueous-based acrylic polymer blend barrier basecoat, wherein an oleophobicity of the aqueous-based acrylic polymer blend barrier basecoat is higher than an oleophobicity of the aqueous-based acrylic polymer blend barrier topcoat.

### PRIORITY

This application claims priority from U.S. Ser. No. 63/504,007 filed on May 24, 2023, the entire contents of which are incorporated herein by reference.

### FIELD

The present application relates generally to the field of food packaging materials, and more specifically to a dual ovenable, repulpable coated cellulosic board for forming food vessels.

### BACKGROUND

Food packaging is a crucial aspect of the food industry, as it protects and preserves the quality and safety of food products. Food containers made of paperboard materials are commonly used for the packaging of prepared food products, such as frozen meals, takeout food, and microwaveable dishes. However, paperboard containers suffer from limitations, such as poor barrier properties against water, moisture vapor, oil, and grease, which compromises the integrity and quality of the food products stored within them.

Various attempts have been made to improve the barrier properties of paperboard containers by applying coatings or laminates to the paperboard substrate. These coatings or laminates provide improved barrier properties but are typically non-recyclable or non-repulpable, leading to increased waste and negative environmental impact.

Moreover, there is a growing demand for sustainable and environmentally friendly packaging materials that can be repulped and reused. Repulpability is an important factor in the recycling process, as it allows for the recovery of fibers from used paper products, which can be incorporated into the production of new paper products. Therefore, there is a need for a coated paperboard material that possesses both the necessary barrier properties for protecting the food product and the ability to be repulped, reducing the environmental footprint of the packaging material.

Furthermore, prepared food products often require reheating in various types of ovens, such as conventional ovens or microwave ovens. It is important for the packaging material to be compatible with both types of heating methods, without compromising the barrier properties or causing any adverse effects on the food product. Consequently, there is a need for a dual ovenable, repulpable coated paperboard that is suitable for forming food containers, which can withstand heating in different types of ovens without compromising its functionality or the quality of the food product contained within.

Thus, there remains a need in the art for a dual ovenable, repulpable coated cellulosic board that addresses the aforementioned challenges and provides improved barrier properties while being repulpable and suitable for heating in conventional ovens and microwave ovens.

### SUMMARY

This present description pertains to a dual ovenable, repulpable coated cellulosic board and method for manufacturing thereof. The dual ovenable, repulpable coated cellulosic board comprises a cellulosic board substrate having a first major side and a second major side, an aqueous-based acrylic polymer blend barrier basecoat on the first major side of the cellulosic board substrate, and an aqueous-based acrylic polymer blend barrier topcoat on the acrylic polymer blend barrier basecoat. An oleophobicity of the aqueous-based acrylic polymer blend barrier basecoat is higher than an oleophobicity of the aqueous-based acrylic polymer blend barrier topcoat.

This present description pertains to a method for manufacturing a dual ovenable, repulpable coated cellulosic board for forming food containers, the method comprising: coating an aqueous-based acrylic polymer blend barrier basecoat on a first major side of a cellulosic board substrate; and coating an aqueous-based acrylic polymer blend barrier topcoat on the aqueous-based acrylic polymer blend barrier basecoat, wherein an oleophobicity of the aqueous-based acrylic polymer blend barrier basecoat is higher than an oleophobicity of the aqueous-based acrylic polymer blend barrier topcoat.

Other embodiments of the disclosed coated cellulosic board and method for manufacturing thereof will become apparent from the following detailed description, the accompanying drawings and the appended claims.

### BRIEF DESCRIPTION OF THE DRAWINGS

FIG. 1 is a side view representation of a coated cellulosic board (e.g., coated paperboard) according to the present description.

FIG. 2 is a schematic illustration of an apparatus for producing rolls or sheets of coated cellulosic board (e.g., coated paperboard) of the present description. A preferred method for coating the cellulosic board is by rod applicators.

FIG. 3 is a top view of a coated cellulosic board according to the present description in the form of a blank having radial score lines.

FIG. 4 is a pictorial view of a thermoformed paperboard food vessel (e.g., tray) having been coated on the inside panels according to the present description.

FIG. 5 is an alternate pictorial view of the same thermoformed paperboard food vessel of FIG. 4.

FIG. 6 is a pictorial view of a thermoformed paperboard food vessel with multiple cavities having been coated on the inside panels according to the present invention.

FIG. 7 is a side view representation of a paperboard thermoforming process of the present description.

### DETAILED DESCRIPTION

The present description relates to a dual ovenable, repulpable coated cellulosic board for forming food containers comprising: a cellulosic board substrate having a first major side and a second major side; an aqueous-based acrylic polymer blend barrier basecoat on the first major side of the cellulosic board substrate; an aqueous-based acrylic polymer blend barrier topcoat on the acrylic polymer blend barrier basecoat, wherein an oleophobicity of the aqueous-based acrylic polymer blend barrier basecoat is significantly higher than an oleophobicity of the aqueous-based acrylic polymer blend barrier topcoat. Typically, the first major side of the cellulosic board substrate corresponds to an interior side of the resulting food container and the second major side of the cellulosic board substrate corresponds to an exterior side of the resulting food container.

The cellulosic board substrate of the present description may be made from a variety of cellulosic board materials, such as paperboard, cardboard, fiberboard, or other forms of rigid cellulosic board materials. These cellulosic board materials can be derived from various sources, including but not limited to, wood pulp, recycled paper, agricultural residues, or other plant-based fibers.

The cellulosic board substrate can be designed to be compatible with various food container manufacturing processes, including but not limited to, folding, die-cutting, thermoforming, heat-sealing, gluing, or mechanical joining. This ensures that the cellulosic board substrate can be easily converted into food containers of various shapes and sizes, catering to different food packaging needs.

The cellulosic board substrate may be selected to be microwavable and ovenable to at least 400° F. This ensures that food products packaged in containers made from the cellulosic board substrate can be conveniently heated or reheated without the need for transferring the food to another container. The heat resistance of the substrate enables the containers to maintain their structural integrity and protect the food product during the heating process. Additionally, the ovenable and microwavable properties of the substrate help to reduce the need for additional packaging materials, potentially leading to less waste and a reduced environmental footprint.

In an aspect, the cellulosic board substrate comprises a paperboard substrate. A paperboard substrate is a type of cellulosic board material that is generally thicker, denser, and more rigid than common paper. Paperboard may be preferable for several reasons. First, paperboard is lightweight yet strong, providing the necessary structural rigidity and durability for food containers without adding excessive weight. Also, paperboard is widely available and can be easily sourced from sustainable and renewable resources, such as virgin wood pulp or recycled fibers. Further, paperboard can be easily formed into various shapes and sizes, making it highly versatile for a wide range of food packaging applications.

The paperboard substrate may be formed from various grades of hardwood, softwood, or combinations thereof. Preferably, the paperboard substrate includes softwood fibers, which have a higher length than hardwood fibers. The long softwood fibers are more conducive to thermoforming. In an aspect, the paperboard substrate includes at least 1%, by weight, softwood fibers. In another aspect, the paperboard substrate includes at least 10%, by weight, softwood fibers. In yet another aspect, the paperboard substrate includes at least 20%, by weight, softwood fibers. In yet another aspect, the paperboard substrate includes at least 30%, by weight, softwood fibers. In yet another aspect, the paperboard substrate includes at least 40%, by weight, softwood fibers. In yet another aspect, the paperboard substrate includes at least 50%, by weight, softwood fibers. In yet another aspect, the paperboard substrate includes at least 60%, by weight, softwood fibers. In yet another aspect, the paperboard substrate includes at least 70%, by weight, softwood fibers. In yet another aspect, the paperboard substrate includes at least 80%, by weight, softwood fibers. In yet another aspect, the paperboard substrate includes at least 90%, by weight, softwood fibers.

The cellulosic board substrate may comprise, for example, solid bleached sulfate (SBS) paperboard substrate. SBS paperboard may be preferable for a number of reasons. First, SBS paperboard is known for its high brightness and excellent smoothness, which can enhance the visual appeal of the food containers. Second, SBS is produced from bleached chemical pulp, typically from virgin fibers, resulting in a substrate with consistent quality, strength, and performance characteristics. This consistency can be advantageous for maintaining the integrity and reliability of the food containers. Finally, SBS is easily formable and compatible with various food container manufacturing processes, including folding, die-cutting, thermoforming, heat-sealing, gluing, and mechanical joining, further enhancing its versatility for food packaging applications.

The cellulosic board substrate can have varying thicknesses, densities, and mechanical properties, depending on the desired application and performance requirements for the food container. Typically, the caliper thickness of the cellulosic board substrate will be about 7 point or more to ensure the rigidity and structural integrity needed for various food packaging applications. In an aspect, a cellulosic board substrate may have a caliper thickness in a range from about 7 point to about 30 point. In an aspect, the cellulosic board substrate may have a caliper thickness in a range from about 16-point to about 29 point. A typical cellulosic board substrate of the present invention may be constructed from about 20 point solid bleached sulphate (SBS) paperboard.

The cellulosic board substrate may also include additional layers or components incorporated within the cellulosic substrate to enhance its properties. The cellulosic board substrate can be treated or modified to improve its performance characteristics, such as its moisture resistance, thermal stability, and mechanical strength. Treatments can include chemical or physical modifications, such as the addition of wet-strength additives, sizing agents, or the use of mechanical refining processes.

In an aspect, the cellulosic board substrate is preferably not clay-coated on one or both of the first and second major sides. It has been found that the presence of a clay-coating on cellulosic board substrate, when used for thermoforming, is not ideal, as the clay-coating is prone to cracking or sticking to heated matched metal tools used in the thermoforming process, for which the temperature of these matched metal tools can range from 200-425° F. Instead, non-clay-coated cellulosic board substrates are a more desirable option.

The aqueous-based acrylic polymer blend barrier basecoat and topcoat of the present description can be formulated using a variety of acrylic polymers, copolymers, and blends thereof, which may provide suitable barrier properties, adhesion to the cellulosic board substrate, and compatibility between the basecoat and topcoat layers. The acrylic polymer blend may include, but is not limited to, homo- or copolymers of acrylic acid, methacrylic acid, acrylates, methacrylates, acrylonitrile, acrylamides, or other acrylic monomers, as well as combinations thereof.

The compositions of the acrylic polymer blend barrier basecoat and topcoat may also include various additives and modifiers to enhance their performance, such as crosslinking agents, plasticizers, stabilizers, dispersants, defoamers, rheology modifiers, pigments, or fillers. These additives may be selected based on their ability to improve the barrier properties, adhesion, processability, or other desired characteristics of the coatings.

The aqueous-based acrylic polymer blend barrier basecoat and topcoat may incorporate a pigment to provide various functionalities, such as color, opacity, or additional barrier properties. Pigments can be selected from a wide range of organic and inorganic materials. The choice of pigment may depend on the desired visual appearance, barrier performance, or other specific requirements of the food container. In some cases, the pigment may also contribute to the oleophobicity or hydrophobicity of the coating, further improving the overall barrier performance of the food container.

In an aspect, the pigment is preferably a microwave-safe pigment. Microwave-safe pigments are selected to not interfere with the microwave heating process and to remain stable under the conditions encountered in a microwave oven. This is important because certain pigments, especially those containing metal or metallic components, can cause arcing or other undesirable reactions when exposed to microwave radiation, which can potentially damage the food container, the microwave oven, or the food product itself. Microwave-safe pigments can include a variety of organic and inorganic materials that do not contain metal or metallic components and have been proven to be stable and safe for use in microwave ovens. Examples of such pigments include certain types of carbon black, organic dyes, and some inorganic pigments that do not contain metallic elements. The choice of a microwave-safe pigment ensures that the food container maintains its visual appeal and performance characteristics without compromising the safety and functionality of the microwave heating process.

When present, the pigment is preferably included in a sufficient amount to provide for substantial opacity to enhance the aesthetic appeal of the food container. A higher opacity can give the container a more premium appearance and can also help conceal any imperfections or discolorations in the cellulosic board substrate. Additionally, an opaque coating may help to protect the contents of the food container from light exposure, which could potentially degrade certain food products over time. To achieve the desired level of opacity, the pigment concentration in the acrylic polymer blend barrier basecoat and topcoat can be adjusted based on the specific properties of the pigment.

The pigment may be present in the basecoat and/or the topcoat. Preferably, the pigment is present in the basecoat and the topcoat is clear. The presence of the pigment primarily in the basecoat, while maintaining a clear topcoat, can offer several advantages. First, it may ensure that the basecoat provides a consistent, aesthetically appealing appearance and effectively conceals any imperfections or discolorations in the cellulosic board substrate, while the clear topcoat allows for unobstructed visibility of the basecoat's color and texture, resulting in an attractive and visually appealing food container. Furthermore, having the pigment in the basecoat allows for the topcoat to focus primarily on providing barrier properties and surface protection, without accommodating for pigments. By incorporating the pigment into the basecoat, it is possible to create a range of desired appearances, as different pigments can be selected based on the specific requirements and desired aesthetics of the food container. Additionally, the use of pigments in the basecoat or topcoat may enhance the overall barrier performance of the food container, as certain pigments can contribute to the oleophobicity or hydrophobicity of the coating.

In an aspect, the basecoat may be coated directly on, i.e., with no intervening layers, the first major side of the cellulosic substrate. The significance of this direct contact is that it ensures an intimate contact between the basecoat and the substrate, which may enhance the sealing properties of the basecoat and reducing the possibility of oil, grease, or moisture penetration into the cellulosic board. This may also provide better adherence to the substrate, consequently improving the overall performance, durability, and barrier properties of the resulting food container. Alternatively, an additional basecoat may be provided therebetween.

In another aspect, the topcoat may be coated directly on, i.e., with no intervening layers, the basecoat. The significance of this direct contact is that it may promote better compatibility and bonding between the topcoat and the basecoat, potentially improving barrier performance. Furthermore, direct contact may ensure that the overall coating system is more streamlined and cost-effective, as it eliminates the need for extra materials or processing steps, ultimately contributing to a more efficient production process and a higher quality dual ovenable, repulpable coated cellulosic board. Alternatively, an additional intermediate coating may be provided therebetween.

In another aspect, the topcoat may define an outermost surface of the cellulosic material, i.e., with no additional layers thereon. The significance of the topcoat being the outermost layer is that it may provide a robust barrier against external factors, such as moisture, grease, and heat, while also offering a smooth, aesthetically appealing surface. The topcoat's position as the outermost layer allows it to protect the basecoat and substrate from potential damage or contamination, ensuring that the overall integrity and performance of the dual ovenable, repulpable coated cellulosic board are maintained throughout the food container's lifecycle. Additionally, having the topcoat as the outermost layer may improve the case of use, as the hydrophobic properties can facilitate the removal of food from the surface and release from tooling. Alternatively, an additional top coating may be provided thereon.

The aqueous-based acrylic polymer blend barrier basecoat and topcoat can be applied to the cellulosic board substrate using a variety of coating techniques, such as roll coating, curtain coating, blade coating, spray coating, gravure roll, a flex-coater, a rod coater, an air knife, or a screen blade, among other suitable methods. A preferred method for coating the cellulosic board substrate is by rod applicators. The step of coating the basecoat and the step of coating the topcoat may employ the same coating method or may employ different coating methods. Rod coating is a preferred embodiment of the present description for both the step of coating the basecoat and the topcoat. The coating weight of each layer may be selected to provide the desired balance of barrier properties, adhesion, and compatibility between the layers. The coating weight for each layer may range from about 1 dry gram per m2 to about 50 dry grams per m2.

The aqueous-based acrylic polymer blend barrier basecoat and topcoat may be applied by coating an aqueous-based colloidal acrylic polymer blend barrier basecoat and an aqueous-based colloidal acrylic polymer blend barrier topcoat on the cellulosic board substrate. Coating the basecoat and topcoat as a colloidal suspension provides a more uniform distribution of the acrylic polymer blend, which can improve the overall barrier properties and adhesion to the cellulosic board substrate. The aqueous-based colloidal acrylic polymer blend barrier basecoat and topcoat may be prepared by dispersing the acrylic polymer blend in water with appropriate dispersants, surfactants, and other additives as desired to achieve the desired rheology, stability, and performance characteristics.

The basecoat may preferably have a coating weight of about 4 to about 20 dry grams per m2. If the coating weight is significantly lower than about 4 dry grams per m2, then the basecoat may provide insufficient coverage of the cellulosic board substrate or may provide insufficient flexibility for topcoat adherence during the forming of the container. If the coating weight is significantly greater than about 20 dry grams per m2, then the cost may increase, and the repulpability of the coated cellulosic board may be inhibited.

The topcoat may preferably have a coating weight of about 3 to about 20 dry grams per m2. If the coating weight is significantly lower than about 3 dry grams per m2, then the topcoat may provide insufficient barrier properties. If the coating weight is significantly greater than about 20 dry grams per m2, then the cost may increase, and the repulpability of the coated cellulosic board may be inhibited.

In an aspect, the basecoat and the topcoat have a combined coating weight of about 5 to about 50 dry grams per m2, preferably about 7 to about 40 dry grams per m2. The combined coating weight of the basecoat and the topcoat, ranging from about 7 to about 40 dry grams per m2, may provide optimal performance in terms of barrier properties, adhesion, compatibility between the layers, and the overall functionality of the coated cellulosic board for food container applications. Adjustments in the combined coating weight may be made depending on the specific requirements for different food container applications. For example, a higher combined coating weight may be necessary for containers intended to hold particularly greasy or moist foods, while a lower combined coating weight may be sufficient for packaging dry or less oily foods. Additionally, the specific properties of the cellulosic board substrate, such as its thickness, density, and mechanical properties, may also influence the ideal combined coating weight for achieving the desired performance.

The basecoat and topcoat may be dried or cured after application, using methods such as air drying, infrared drying, convection drying, ultraviolet (UV) curing, or a combination of these methods, to ensure proper adhesion to the cellulosic board substrate and compatibility between the layers.

According to the present description, the oleophobicity of the aqueous-based acrylic polymer blend barrier basecoat is significantly higher than the oleophobicity of the aqueous-based acrylic polymer blend barrier topcoat. Although the present invention is not limited by theory, it is believed that the difference in oleophobicity between the basecoat and topcoat serves several purposes.

First, the higher oleophobicity of the basecoat provides a strong barrier against oils and greases, protecting the cellulosic board substrate from penetration by these substances. This is important because oil and grease can weaken the structure of the cellulosic board and lead to the breakdown of the food container. Preventing penetration helps to maintain the structural integrity of the food container. Additionally, if the topcoat experiences any failures, such as during the process of forming the container or thereafter during use of the container, the basecoat remains as a primary barrier to protect the substrate from oil and grease penetration.

Second, when the cellulosic substrate is coated with the basecoat, a portion of the basecoat may penetrate the surface of the cellulosic substrate. This may impart oleophobic properties to the substrate's surface, providing the surface of the cellulosic substrate with resistance against the detrimental effects of oil and grease. As a result, the substrate may become more resilient to the weakening effects of oil and grease, improving the overall performance and durability of the food container.

Third, the lower oleophobicity of the topcoat may promote better adhesion between the basecoat and topcoat layers due to the increased compatibility between the two layers. This ensures that the layers remain bonded during food container manufacturing processes, such as forming, folding, and sealing, ultimately contributing to the structural integrity and performance of the finished container.

Fourth, the lower oleophobicity of the topcoat may contribute to better surface properties for food contact, as it may facilitate a more uniform and smooth surface texture. This could result in improved food release properties, making the container more user-friendly. Additionally, a smoother surface may also enhance the visual appeal of the food container, making it more attractive to consumers.

Fifth, if oil and grease manage to penetrate the topcoat, the difference in oleophobicity between the two layers could create a barrier effect, discouraging the oil and grease from permeating through the basecoat to the cellulosic substrate. This may effectively trap the oil and grease within the topcoat layer, further protecting the substrate and maintaining the integrity of the food container.

In an aspect of the present description, the aqueous-based acrylic polymer blend barrier basecoat is preferably oleophobic.

In another aspect of the present description, the aqueous-based acrylic polymer blend barrier topcoat is preferably hydrophobic. The hydrophobic nature of the topcoat is believed to provide several benefits for the food container.

First, a hydrophobic topcoat helps to prevent the absorption of water and moisture by the cellulosic board substrate, maintaining its structural integrity and ensuring that the container remains durable and resistant to deformation during use. This is particularly important when packaging food products with high moisture content, as the hydrophobic topcoat prevents moisture migration into the substrate, thereby avoiding the weakening of the container.

Second, the hydrophobic topcoat provides a barrier against condensation that may occur during the transportation, storage, and use of the food container. This prevents the penetration of moisture into the cellulosic board substrate, ensuring that the container remains strong and stable even in humid environments or when exposed to wet conditions.

Third, a hydrophobic topcoat may improve the release properties of the food container, making it easier to remove food products without excessive sticking or residue. This can be especially beneficial for food products with high moisture content or those that may otherwise adhere to the container's surface.

Fourth, the hydrophobic topcoat may contribute to the overall aesthetic appeal of the food container by providing a smooth and glossy surface finish. This can make the container more visually attractive to consumers and may enhance the perception of quality associated with the packaged food product.

The relative oleophobicity of the basecoat and topcoat can be adjusted by modifying the compositions of the acrylic polymer blends, such as by varying the ratio of hydrophobic and hydrophilic monomers in the copolymers, incorporating specific oleophobic additives, or adjusting the degree of crosslinking within the polymer network. For the basecoat, the oleophobicity of the basecoat can be increased by incorporating high-performance oleophobic additives, by using high-molecular-weight, amphiphilic block copolymers or graft copolymers that have both hydrophobic and olcophobic segments, and by increasing the degree of crosslinking within the polymer network. For the topcoat, the oleophobicity of the topcoat can be decreased by utilizing hydrophilic monomers in the copolymer blend, by opting for additives that specifically enhance hydrophobicity, such as hydrophobic particles, without significantly affecting oleophobicity, and by decreasing the degree of crosslinking within the polymer network. To ensure hydrophobicity of the topcoat, the hydrophobicity of the topcoat can be increased by using a higher proportion of hydrophobic monomers, such as alkyl methacrylates or alkyl acrylates, with longer alkyl chains to improve water resistance, by incorporate hydrophobic additives, such as hydrophobic particles, and by optimize the degree of crosslinking within the polymer network to high hydrophobicity while maintaining the desired lower oleophobicity.

In an aspect of the present description, the oleophobicity of the aqueous-based acrylic polymer blend barrier basecoat is significantly higher than the oleophobicity of the aqueous-based acrylic polymer blend barrier topcoat, as determined by contact angle testing. In one expression, the aqueous-based acrylic polymer blend barrier basecoat exhibits a contact angle at least 1 percent greater than the contact angle exhibited by the aqueous-based acrylic polymer blend barrier topcoat (at the same conditions). In another expression, the aqueous-based acrylic polymer blend barrier basecoat exhibits a contact angle at least 2 percent greater than the contact angle exhibited by the aqueous-based acrylic polymer blend barrier topcoat (at the same conditions). In another expression, the aqueous-based acrylic polymer blend barrier basecoat exhibits a contact angle at least 5 percent greater than the contact angle exhibited by the aqueous-based acrylic polymer blend barrier topcoat (at the same conditions). In yet another expression, the aqueous-based acrylic polymer blend barrier basecoat exhibits a contact angle at least 10 percent greater than the contact angle exhibited by the aqueous-based acrylic polymer blend barrier topcoat (at the same conditions).

In addition to oleophobicity and excellent oil barrier properties, the basecoat serves the traditional function of a basecoat, which includes sealing the underlying surface of the cellulosic board substrate, providing flexibility characteristics for processes such as thermoforming or folding, and providing for adherence with the topcoat. The basecoat can be selected from commercially available aqueous-based olcophobic colloidal acrylic polymer blends, which may be primarily comprised of acrylic polymer or may have less than 50% by weight of total polymer units of the aqueous-based polymer-dispersion basecoat derived from acrylic polymer.

In addition to hydrophobicity and excellent water and vapor barrier properties, the topcoat serves the traditional function of a topcoat, which includes providing a protective layer over the basecoat and enhancing the aesthetic appeal of the food container. The topcoat may also acts as a slip-agent to release the food vessel from the thermoforming or other tooling.

The topcoat can be selected from commercially available aqueous-based hydrophobic colloidal acrylic polymer blends, which may be primarily comprised of acrylic polymer or may have less than 50% by weight of total polymer units of the aqueous-based polymer-dispersion topcoat derived from acrylic polymer.

In a preferred aspect, the basecoat and topcoat do not contain styrene butadiene. In this preferred aspect, by excluding styrene butadiene from the basecoat and topcoat formulations, the overall composition of the coatings becomes more appealing due to reduced odor. Styrene butadiene is a synthetic rubber that, while offering certain functional benefits, can be less desirable due to its noticeable odor, which may affect the overall perception and user experience of the food containers.

Additional properties of the coatings may include: (a) mass stability at temperatures below about 400° F., i.e., below 400° F. the coatings will not melt, degrade or otherwise lose mass (for instance, by a solvent outgassing); (b) capable of being tack bonded at temperatures of about 250° F. or greater; (c) chloroform-soluble extractives levels do not exceed about 0.5 mg/in² of food contact surface when exposed to a food simulating solvent, for example, N-Heptane at 150° F. for two hours; and (d) is flexible enough to withstand conventional creasing in a cross direction with a 2 point male rule and 0.62 inch channel while sustaining a crack length ratio, defined as total length of cracks per total length of score, of no greater than about 0.1; and (c) exhibits resistance to blocking when stacked at ambient conditions under a load of about 0.5 lbs/sq in or greater; and (f) is resilient enough for thermoforming at temperatures about 200 to about 425° F. without degradation or damage. These properties are significant because they assure that the multilayer coating will not crack during thermoforming, or folding and forming to contaminate the food in contact with the coating during storage and use of the food vessel, and the blanks or food vessel can be separated by conventional feed systems.

Mass stability may be determined by a Thermal Gravimetric Analysis (TGA) plot, which is a measure of the weight of a coating sample plotted against temperature. Any significant weight loss indicates product outgassing. By way of the term “dual ovenable”, it is understood that the coatings of the present description are ovenable and microwavable. By way of the term “ovenable,” it is understood that the coatings of the present description have mass stability at temperatures below about 400° F., i.e., below about 400° F. the coatings will not melt, degrade, or otherwise lose mass (for instance, by a solvent outgassing). By way of the term “microwaveable” means the coating can be placed together with food into a microwave oven and microwaved so as to heat the food without the melting of the coating or otherwise causing transferring of the coating to the food.

As further mentioned below, a film (e.g., a PET lidstock film) may be tack bonded at temperatures of 250° F. or greater to the multilayer thermoformable dual ovenable coating to seal a food vessel thermoformed therefrom. One of the aspects of the multilayer thermoformable dual ovenable coating is capability of being tack bonding at temperatures of 250° F. or greater to the aqueous-based polymer-dispersion barrier topcoat.

Chloroform-soluble extractives levels may be determined by an extraction test, which measures non-transfer of substances from the package to the food product. Coated paperboard may be tested by use of an extraction cell described in the “Official Methods of Analysis of the Association of Official Analytical Chemists,” 13th Ed. (1980) sections 21.010-21.015, under “Exposing Flexible Barrier Materials for Extraction.” A suitable food simulating solvent for tray applications described would be N-Heptane. The N-Heptane should be a reagent grade, freshly redistilled before use, using only material boiling at 208° F. The extraction methodology consists of, first, cutting the lid sample to be extracted to a size compatible with the clamping device chosen. Next, the sample to be extracted is placed in the device so that the solvent only contacts the food contact surface. The solvent is then added to the sample holder and placed in an oven for two hours at 150° F. At the end of the exposure period, the test cell is removed from the oven and the solvent is poured into a clean Pyrex® flask or beaker, being sure to rinse the test cell with a small quantity of clean solvent. The food-simulating solvent is evaporated to about 100 millimeters in the container, and transferred to a clean, tared evaporating dish. The flask is washed three times with small portions of the Heptane solvent and the solvent is evaporated to a few millimeters on a hot plate. The last few millimeters should be evaporated in an oven maintained at a temperature of approximately 221° F. The evaporating dish is cooled in a desiccator for 30 minutes. A chloroform extraction is then performed by adding 50 milliliters of reagent grade chloroform to the residue. The mix is warmed, filtered through a Whatman No. 41 filter paper in a Pyrex® funnel and the filtrate is collected in a clean, tared evaporating dish. The chloroform extraction is then repeated by washing the filter paper with a second portion of chloroform. This filtrate is added to the original filtrate and the total is evaporated down to a few millimeters on a low temperature hot plate. The last few millimeters should be evaporated in an oven maintained at approximately 221° F. The evaporating dish is cooled in a desiccator for 30 minutes and weighed to the nearest 0.1 milligram to get the chloroform-soluble extractives residue. To be assured that there is no appreciable coating transfer to the food product, the chloroform-soluble extractives should not exceed about 0.5 mg/in².

Flexibility of the multilayer thermoformable dual ovenable coating may be determined by using iodine to stain scored areas. The coated paperboard is subjected to conventional creasing in a cross direction with a 2 point male rule and 0.62 inch channel. Iodine is applied to stain scored areas. The iodine technique makes any cracks in the applied coating extremely visible. Cracking on each score is then evaluated as to average crack size and coverage (lengthwise) over a one-inch score area. The crack length ratio, defined as total length of cracks per total length of score, of no greater than about 0.1 is measured.

Block resistance of the multilayer thermoformable dual ovenable coating is important when blanks or trays are stacked at ambient temperatures under a load of about 0.5 lbs./sq. in. or greater. Blanks or food vessels of the present disclosure may be stacked after manufacture of the blanks or food vessels. Typically, blanks may be cased (approximately 1000/case) or palletized. The pallets are then stacked creating fairly high (0.5 lbs/sq. in.) loads on the bottom layers of blanks. Food vessels may be “nested” and delivered and shipped in a similar manner. When the food vessels or blanks are unpacked by an end user, they are typically loaded into a mechanical devise which separates the articles and transfers them to a conveyer or sealing device. If the blanks or food vessels have any attraction to one another, the aqueous-based polymer-dispersion barrier topcoat should have the necessary properties which allows for easy separation.

For thermoforming or other forming of food vessels, the coated substrates of the present description may have resilience at temperatures of about 200 to about 425° F. without degradation or damage. This property may be significant because they assure that the multilayer coating will not crack during thermoforming, or folding and forming to contaminate the food in contact with the coating during storage and use of the food vessel, and the blanks or food vessel can be separated by conventional feed systems.

Exemplary available coatings for the basecoat include Oleo-Pak 4100 or OGR-Westrock-0008 from Detrapel, which are aqueous-based, olcophobic colloidal acrylic polymer blends. Exemplary available coatings for the topcoat include Hydro-Pak 4040 or MVTR-Westrock-0009 from Detrapel, which are aqueous-based, hydrophobic colloidal acrylic polymer blends.

According to the present description, the basecoat and topcoat are coated on the first major side of the cellulosic board substrate, which typically corresponds to an interior side of the resulting food vessel. In an aspect, the aqueous-based acrylic polymer blend barrier basecoat may also be coated on the second major side of the cellulosic board substrate, which typically corresponds to an exterior side of the resulting food vessel. In this aspect, the aqueous-based acrylic polymer blend barrier topcoat may also be coated on the basecoat of the second major side of the cellulosic board substrate. These additional coatings on the second major side may enhance the overall performance of the food container by providing improved oil and grease resistance, moisture barrier properties, and durability to both the interior and exterior sides of the food vessel. This dual-sided coating approach can be particularly beneficial for food products with high moisture content, oily or greasy components, or in situations where the food container may be exposed to various environmental conditions during transportation, storage, or use. Also, providing the coatings on both sides of the paperboard substrate acts as a high heat slip agent for tooling release during thermoforming or other forming. Alternatively, different basecoats and/or topcoats may be applied to the second major side of the cellulosic board substrate.

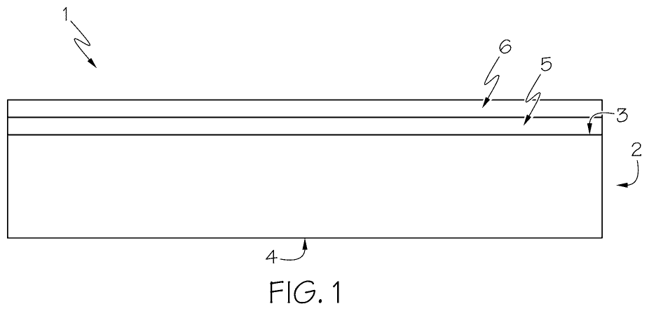

With reference to FIG. 1, there is illustrated a side view of an exemplary coated cellulosic board (e.g., coated paperboard). The coated paperboard 1 includes a ovenable uncoated cellulosic substrate (e.g., paperboard substrate) 2 having a first major side 3 and a second major side 4, a continuous coating of a dried aqueous-based oleophobic acrylic polymer blend barrier basecoat 5 directly on the first major side 3 of the paperboard substrate 2, and a continuous coating of a dried aqueous-based hydrophobic acrylic polymer blend barrier topcoat 6 directly on the dried aqueous-based oleophobic acrylic polymer blend barrier basecoat 5. The second major side 4 may or may not have its own inks or various aqueous based coatings. For example, the outside surface may include one or both aqueous-based oleophobic acrylic polymer blend barrier basecoat and the aqueous-based hydrophobic acrylic polymer blend barrier topcoat.

The present disclosure relates to methods for manufacturing thermoformable dual ovenable coated cellulosic boards (e.g., coated paperboards), including steps of rod or press-applied coating the aqueous-based olcophobic acrylic polymer blend barrier basecoat on the first major side of the cellulosic board substrate (e.g., paperboard substrate) and rod or press-applied coating an aqueous-based hydrophobic acrylic polymer blend barrier topcoat on the aqueous-based oleophobic acrylic polymer blend barrier basecoat.

In an aspect, the methods for manufacturing thermoformable dual ovenable coated cellulosic boards may include treating the aqueous-based oleophobic acrylic polymer blend barrier basecoat to have a surface tension in a range of 43 dyne/cm to 60 dyne/cm, such as by corona treatment, followed by the step of rod or press-applied coating the aqueous-based hydrophobic acrylic polymer blend barrier topcoat on the aqueous-based polymer-dispersion oleophobic acrylic polymer blend barrier basecoat.

The coating steps may be performed by any suitable methods. A preferred method for coating the cellulosic board is by rod applicators. The step of coating the aqueous-based oleophobic acrylic polymer blend barrier basecoat and the step of coating an aqueous-based hydrophobic acrylic polymer blend barrier topcoat may employ the same coating method or may employ different coating methods. Rod coating is a preferred embodiment of the present disclosure for both the step of coating the aqueous-based oleophobic acrylic polymer blend barrier basecoat and the step of coating an aqueous-based hydrophobic acrylic polymer blend barrier topcoat.

In an aspect, the step of coating the aqueous-based oleophobic acrylic polymer blend barrier basecoat comprises coating the aqueous-based basecoat to a basis weight of about 4 to about 20 dry grams per m2. In another aspect, the step of coating the aqueous-based hydrophobic acrylic polymer blend barrier topcoat comprises coating the aqueous-based hydrophobic acrylic polymer blend barrier topcoat to a basis weight of about 3 to about 20 dry grams per m2. In yet another aspect, the aqueous-based oleophobic acrylic polymer blend barrier basecoat and the aqueous-based oleophobic acrylic polymer blend barrier topcoat have a combined basis weight of about 7 to about 40 dry grams per m2.

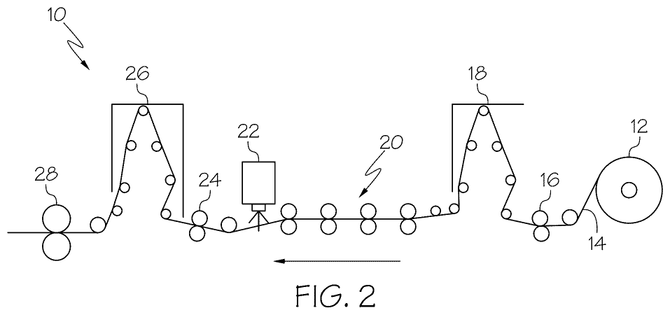

FIG. 2 illustrates a schematic illustration of an exemplary apparatus 10 for producing rolls or sheets of coated cellulosic board (e.g., coated paperboard) of the present description, in particular a reel handling system 10. This illustration depicts production of coated paperboard blanks. In particular, the apparatus 10 may include a paper roll 12, a paperboard substrate 2 in the form of a paperboard roll web 14, a first coating station 16, a first coating dryer 18, printing station 20, curing station 22, a second coating station 24, a second coating dryer 26, cutters 28, resulting in coated paperboard blanks. A preferred method for coating the cellulosic board is by rod applicators.

During the operation of apparatus 10, paper roll 12 is unrolled such that paperboard roll web 14 is formed. Paperboard roll web 14 is traversed along apparatus 10 by conventional techniques to first coating station 16. At the first coating station 16, paperboard roll web 14 is coated with the aqueous-based oleophobic acrylic polymer blend barrier basecoat 5 of the present description on the first major side 3 of the paperboard roll web 14. The aqueous-based oleophobic acrylic polymer blend barrier basecoat 5 may be continuously applied or patterned applied at the first coating station 16 on the first major side 3 of the paperboard roll web 14 by any conventional coating technique (e.g., a gravure roll, a flex-coater, a rod coater, an air knife, a screen blade) mentioned earlier at a deposition rate of, preferably, about 4 to about 20 dry grams per m2 for the basecoat 5. Rod coating is a preferred embodiment of the present disclosure. Following the application of the aqueous-based oleophobic acrylic polymer blend barrier basecoat 5 upon paperboard roll web 14, paperboard roll web 14 is traversed to a first coating dryer 18 where the aqueous-based oleophobic acrylic polymer blend barrier basecoat is dried. After drying, the paperboard roll web 14 may be cooled through contact with conventional drum chillers (not shown). The paperboard roll web 14 is traversed along apparatus 10 by conventional techniques to second coating station 24. At the second coating station 24, paperboard roll web 14 is coated with the aqueous-based hydrophobic acrylic polymer blend barrier topcoat 6 of the present description on top of the aqueous-based oleophobic acrylic polymer blend barrier basecoat 5. The aqueous-based hydrophobic acrylic polymer blend barrier topcoat 6 may be continuously applied or patterned applied at the second coating station 24 by any conventional coating technique (e.g., a gravure roll, a flex-coater, a rod coater, an air knife, a screen blade) mentioned earlier at a deposition rate of, preferably, about 3 to about 20 dry grams per m2 for the topcoat. Rod coating is a preferred embodiment of the present disclosure. Following the application of the aqueous-based hydrophobic acrylic polymer blend barrier topcoat 6 upon paperboard roll web 14, paperboard roll web 14 is traversed to a second coating dryer 26 where the aqueous-based hydrophobic acrylic polymer blend barrier topcoat 6 is dried. The process depicted in FIG. 2 is illustrated as continuous, but the process can be broken into steps at the same or different facilities. FIG. 2 is only one exemplary sequence as related to the application of the basecoat 5, topcoat 6 of the present description. Following the application of basecoat 5 and topcoat 6, paperboard roll web 14 is traversed to cutting mechanism (e.g., cutters 28) which cuts the paperboard roll web 14 into the desired blank size and scores the blank to provide desired score lines (e.g., radial score lines) for subsequent thermoforming. For example, the cutting mechanism may be a rotary cutting system. Alternatively, one may choose to wind the paperboard roll web 14 in roll form or sheet the web for cutting and scoring at a later time.

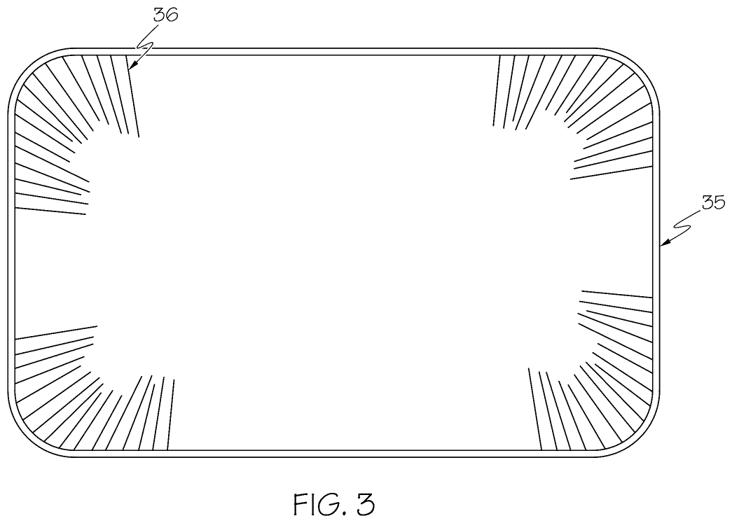

The present disclosure relates to coated cellulosic board substrates in the form of a blank. FIG. 3 is a top view of an exemplary coated cellulosic board according to the present description in the form of a blank 35 having radial score lines 36 suitable for thermoforming. The blank 35 has multiple score lines 36 that are close together at each corner of the blank 35. The score lines 36 enable for the formation of pleats that result when the blank 35 is thermoformed. The coating of the present description do not crack or otherwise get damaged when the scores 36 become pleats to ensure for the desired barrier properties. The illustrated score lines 36 are one exemplary representation of radial score lines. Actual scoring may be more or less.

The present disclosure relates to methods for manufacturing a thermoformed dual ovenable coated cellulosic board food vessel, in which the coated cellulosic board as previously described is thermoformed into the form of a thermoformed dual ovenable coated cellulosic board food vessel.

The thermoforming may be performed in any conventional manner. For example, thermoforming may be performed using thermoforming machines manufactured by Peerless Machine or Gralex Industries. A specific exemplary thermoforming process is described as follows.

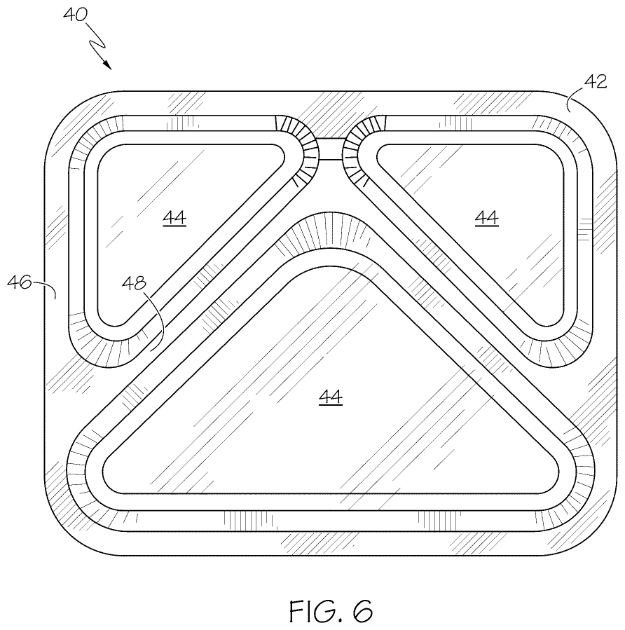

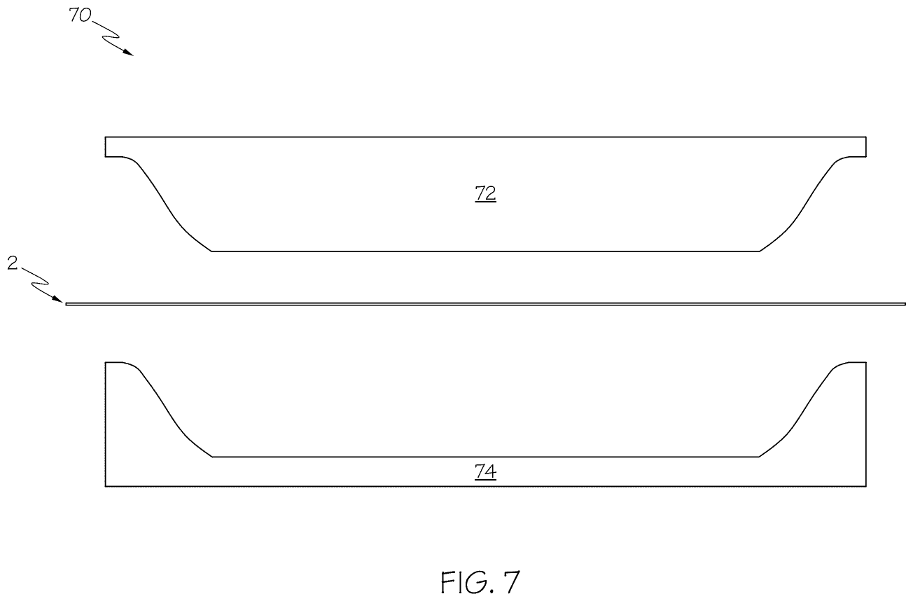

Typically, a web of coated paperboard to be thermoformed into a paperboard food vessel are blanked and scored and delivered to a thermoforming press 70 as a stack of blanks. FIG. 6 is schematic representation of a cross-section of a male die 72 and a female die 74 of the thermoforming press 70 used for thermoforming the blank 35 into a paperboard food vessel (e.g., tray or bowl). It will be understood that the male die 72 and the female die 74 as illustrated in FIG. 6 are merely exemplary, and that thermoforming systems may include a variety of modifications and alternatives including but not limited dividers and cavities. FIG. 7 is a side view representation of a paperboard thermoforming process of the present description.

At the thermoforming press 70, the blank 35 is thermoformed with the male die 72 and the female die 74 using heat and pressure to form a paperboard food vessel.

Thus, the blank 35 is heated, drawn into the temperature-controlled female die 74 by the temperature-controlled male die 72, and then held against the surfaces of the male die 72 and female die 74 until cooled.

The temperature of the female-die 74 is controlled to be at a higher temperature than the male die 72. The first major side 3 of the paperboard substrate 2 is arranged to face the male die 72 and the second major side 4 of the paperboard substrate 2 is arranged to face the female die 74.

If the temperature of the male die 72 is too low, then the basecoat 5 and topcoat 6 as well as the paperboard substrate 2 may be insufficiently heated and the resulting paperboard food vessel may not be strongly formed to the desired shape. If the temperature of the male die 72 is too high, then the basecoat 5 and/or topcoat 6 may stick to the male die 72. Accordingly, in an aspect, the male die 72 preferably has a temperature of approximately 80-220° F. If the paperboard substrate 2 were to have clay coating that substrate may stick in the thermoform tooling. In an aspect, the female die may have a temperature of approximately 200-425° F.

In an aspect, a moisture content of the coated paperboard 1 is controlled during the thermoforming process. The moisture content may be controlled by, for example, using a humidifier to control an atmospheric humidity or addition of moisture directly to the coated paperboard.

If the moisture content of the coated paperboard 1 is too high, then blistering of the basecoat 5 and/or topcoat 6 may occur. If the moisture content of the coated paperboard 1 is too low, then corner cracking of the paperboard substrate 2 and the basecoat 5 and/or topcoat 6 may occur. In an aspect, the moisture of the coated paperboard 1 is controlled between 9 and 14% by weight. In another aspect, the moisture of the coated paperboard 1 is controlled between 10 and 13% by weight.

The present disclosure relates to coated cellulosic board food vessels. The coated cellulosic board food vessels may be thermoformed from the previously described coated cellulosic board. The thermoforming may be performed in any manner, such by way of the thermoforming methods described above. Alternatively, the coated cellulosic board food vessels may be formed by other processes such as folding and gluing or joining by mechanical means.

The structure of the coated cellulosic board food vessels are not limited. In an aspect, the coated cellulosic board food vessel may include a coated bottom panel and a coated sidewall panel. In another aspect, the coated cellulosic board food vessel may include a coated bottom panel, a coated sidewall panel, and a coated flange panel.

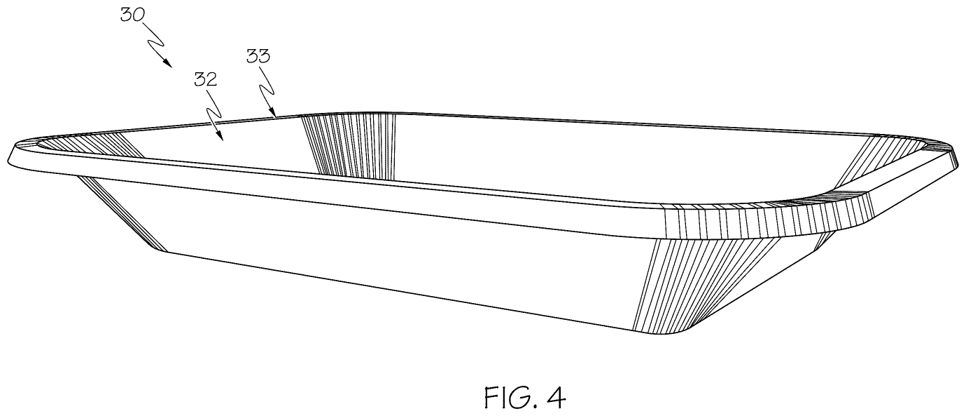

An exemplary food vessel in the form of a food tray is illustrated in FIGS. 3 and 4. With reference to FIG. 3, there is illustrated a thermoformed paperboard food tray 30. Food tray 30 may include in part, a coated bottom panel 31, coated sidewall panel 32, and a coated flange panel 33. The coated panels may be comprised of the coated paperboard 1 of FIG. 1. The coated flange panel 33 can be tack bonded to PET lidstock film, heat-seal coated cellulosic board or similar at temperatures of 250° F. or greater. FIG. 4 is an alternate view of the same food tray 30 and constituent panels 31, 32, 33.

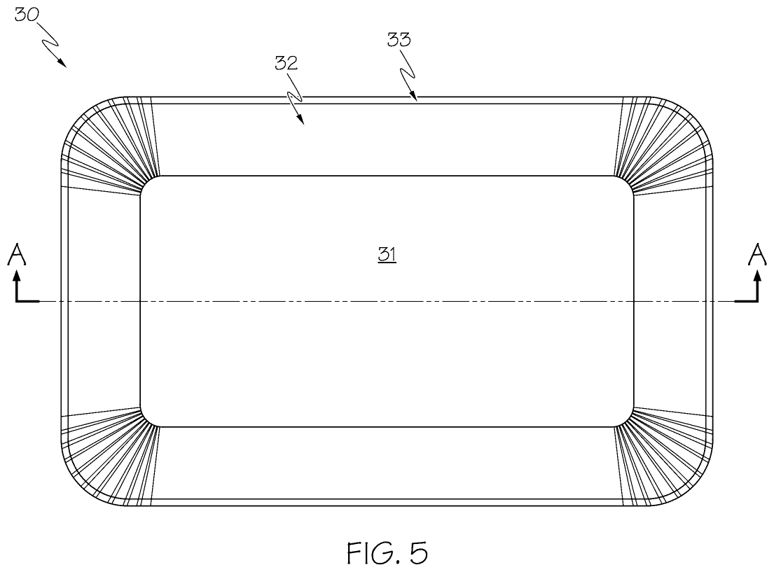

An exemplary food vessel in the form of a food tray is illustrated in FIG. 5. With reference to FIG. 5, food tray 40 may include in part, tray compartments 44, flange 46 and top surface 48. The top surface 48 may correspond to the first major side 3 (having basecoat 5 and topcoat 6) in FIG. 1. The coated flange 46 can be tack bonded to PET lidstock film, heat-seal coated cellulosic board or similar at temperatures of 250° F. or greater. The food tray 40 in FIG. 5 may be cut from a paperboard sheet or web of a great length.

The present disclosure relates to methods of using coated cellulosic board food vessels. In an aspect, a method of using the coated cellulosic board food vessels as previously describe may include placing a food product on the thermoformed dual ovenable coated cellulosic board food vessel and sealing the food product within the thermoformed dual ovenable coated cellulosic board food vessel.

The sealing of the food product within the thermoformed dual ovenable coated cellulosic board food vessel may be performed by any suitable conventional method. In an exemplary aspect, the sealing of the thermoformed dual ovenable coated cellulosic board food vessel may include tack bonding a film to the thermoformed dual ovenable coated cellulosic board food vessel, particularly a flange of the thermoformed dual ovenable coated cellulosic board food vessel.

Although various embodiments of the disclosed coated cellulosic board and methods for manufacturing have been shown and described, modifications may occur to those skilled in the art upon reading the specification. The present application includes such modifications and is limited only by the scope of the claims.

What is claimed is:

1. A method for manufacturing a dual ovenable, repulpable coated cellulosic board for forming food containers, the method comprising:
coating an aqueous-based acrylic polymer blend barrier basecoat on a first major side of a cellulosic board substrate; and
coating an aqueous-based acrylic polymer blend barrier topcoat on the aqueous-based acrylic polymer blend barrier basecoat,
wherein an oleophobicity of the aqueous-based acrylic polymer blend barrier basecoat is higher than an oleophobicity of the aqueous-based acrylic polymer blend barrier topcoat.

2. The method of claim 1, wherein the aqueous-based acrylic polymer blend barrier basecoat is oleophobic.

3. The method of claim 1, wherein the aqueous-based acrylic polymer blend barrier topcoat is hydrophobic.

4. The method of claim 1, further comprising coating an aqueous-based acrylic polymer blend barrier basecoat on a second major side of the cellulosic board substrate.

5. The method of claim 4, further comprising coating an aqueous-based acrylic polymer blend barrier topcoat on the aqueous-based acrylic polymer blend barrier basecoat on the second major side of the cellulosic board substrate.

6. The method of claim 5, wherein an oleophobicity of the aqueous-based acrylic polymer blend barrier basecoat on the second major side is higher than an oleophobicity of the aqueous-based acrylic polymer blend barrier topcoat on the second major side.

7. The method of claim 1, further comprising cutting the cellulosic board having the aqueous-based acrylic polymer blend barrier basecoat and the aqueous-based acrylic polymer blend barrier topcoat thereon to form a blank.

8. The method of claim 7, further comprising scoring the blank.

9. The method of claim 8 wherein the step of scoring the blank comprises radially scoring the blank.

10. A dual ovenable, repulpable coated cellulosic board for forming food containers comprising:
a cellulosic board substrate having a first major side and a second major side;
an aqueous-based acrylic polymer blend barrier basecoat on the first major side of the cellulosic board substrate; and
an aqueous-based acrylic polymer blend barrier topcoat on the aqueous-based acrylic polymer blend barrier basecoat,
wherein an oleophobicity of the aqueous-based acrylic polymer blend barrier basecoat is higher than an oleophobicity of the aqueous-based acrylic polymer blend barrier topcoat.

11. The dual ovenable, repulpable coated cellulosic board of claim 10, wherein the aqueous-based acrylic polymer blend barrier basecoat is oleophobic.

12. The dual ovenable, repulpable coated cellulosic board of claim 10, wherein the aqueous-based acrylic polymer blend barrier topcoat is hydrophobic.

13. The dual ovenable, repulpable coated cellulosic board of claim 10, further comprising an aqueous-based acrylic polymer blend barrier basecoat on the second major side of the cellulosic board substrate.

14. The dual ovenable, repulpable coated cellulosic board of claim 13, further comprising an aqueous-based acrylic polymer blend barrier topcoat on the aqueous-based acrylic polymer blend barrier basecoat on the second major side of the cellulosic board substrate.

15. The dual ovenable, repulpable coated cellulosic board of claim 14, wherein an oleophobicity of the aqueous-based acrylic polymer blend barrier basecoat on the second major side is higher than an oleophobicity of the aqueous-based acrylic polymer blend barrier topcoat on the second major side.

16. The dual ovenable, repulpable coated cellulosic board of claim 10, wherein the aqueous-based acrylic polymer blend barrier basecoat comprises a pigment.

17. The dual ovenable, repulpable coated cellulosic board of claim 10, wherein the aqueous-based acrylic polymer blend barrier basecoat does not contain styrene butadiene.

18. The dual ovenable, repulpable coated cellulosic board of claim 10, wherein the aqueous-based acrylic polymer blend barrier topcoat does not contain styrene butadiene.

19. The dual ovenable, repulpable coated cellulosic board of claim 10 in a form of a cut blank.

20. The dual ovenable, repulpable coated cellulosic board of claim 10 in a form of a scored blank.

21. The dual ovenable, repulpable coated cellulosic board of claim 10 in a form of a radially scored blank.

22. The dual ovenable, repulpable coated cellulosic board of claim 10 in a form of a dual ovenable, repulpable coated cellulosic board food vessel.

23. The dual ovenable, repulpable coated cellulosic board of claim 10 in a form of a thermoformed dual ovenable, repulpable coated cellulosic board food vessel.

24. The dual ovenable, repulpable coated cellulosic board of claim 10 in a form of a folded and glued dual ovenable, repulpable coated cellulosic board food vessel.
